(19) United States
(12) Patent Application Publication
(10) Pub. No.: US 2009/0296671 A1
(43) Pub. Date: Dec. 3, 2009

(54) COMMUNICATIONS BETWEEN A CLIENT DEVICE AND AN INFRASTRUTURE DEVICE

(75) Inventor: Robert BEACH, Los Altos, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/129,458

(22) Filed: May 29, 2008

(51) Int. Cl. H04Q 7/24

(52) U.S. Cl. 370/338

(57) ABSTRACT

Techniques are provided for communicating information between a wireless client device (CD) and an infrastructure device (ID) in a WLAN in which the CD wirelessly communicates with the ID in IBSS mode over a pseudo-BSS/IBSS air interface. The CD includes a WLAN NIC that operates in IBSS mode and a client host system that includes a client custom driver module (CCDM) and a WLAN NIC driver module configured to operate in IBSS mode. The ID includes a hardware interface and a host system which includes a packet separation driver module (PSDM) and an infrastructure custom driver module (ICDM). The CD operates in pseudo-BSS/IBSS mode (PBIM). The CCDM provides pseudo BSS-like service(s) with respect to packets generated by upper protocol layer modules to generate pseudo-BSS-like packets that it provides to the WLAN NIC via WLAN NIC driver module. Based on the pseudo-BSS-like packets, the WLAN NIC generates PBIM packets and transmits them. The PSDM receives packets from the hardware interface and separates them. When the PSDM receives PBIM packets, the PDSM sends the PBIM packets to the ICDM which performs one or more BSS-like services with respect to the PBIM packets.

### FIELD OF THE INVENTION

The present invention generally relates to network communications, and more particularly relates to communications between a client device and an infrastructure device.

### BACKGROUND OF THE INVENTION

Wireless computer networks have been developed in which a wireless client device communicates with a network via an infrastructure device such as an access point (AP) and/or wireless switch. For example, the Institute of Electrical and Electronics Engineers (IEEE) 802.11 Standards define specifications for Wireless Local Area Networks (WLANs) that supports communications between wireless client devices or “stations” and one or more access points (APs). Throughout this document, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained by contacting the IEEE at IEEE, 445 Hoes Lane, PO Box 1331, Piscataway, N.J. 08855-1331, USA.

In IEEE 802.11 WLANs, nodes (e.g., APs and wireless client devices/stations) can operate in one of three modes or “network configurations”: (1) infrastructure or “Basic Service Set (BSS)” mode, (2) ad-hoc or “Independent Basic Service Set (IBSS)” mode, and (3) Wireless Distribution Services (WDS) mode.

BSS mode is used for communications between a client device and an access point (AP) or access port. The client device (sometimes referred to as a station (STA)) communicates over a wireless link with the AP, which is typically connected to a Wide Area Network (WAN) that includes an Internet network. When the client device wants to communicate with another client device, it sends the communication to the AP with which it has previously associated and authenticated. The AP then relays the communication to the other client device possibly via other infrastructure devices such as another AP.

By contrast, IBSS mode or “network configuration” is used for direct, peer-to-peer communications between two or more client devices (STAs) without implicating infrastructure devices such as an AP and/or wireless switch. In IBSS mode, no connection to infrastructure or a wired network is needed. IBSS mode can allow a group users to spontaneously and quickly set up a small, ad hoc WLAN since IBSS mode only requires the installation of radio Network Interface Cards (NICs) in the client devices (STAs). There is no need to install an AP and run cables for connection to a wired network. In some network configurations, particularly when there is a small number of users, IBSS mode can provide better performance since there is no need for packets to travel through an AP and/or other infrastructure devices.

In order to comply with the IEEE 802.11 standards, a client device is required to support both BSS and IBSS modes operation, and much of the IEEE 802.11 standards define a common operation in both modes. Within the MAC Layer, all of the carrier sensing and most of the frame types and corresponding usage are the same regardless of which mode used. The use of IBSS mode only affects the protocols, so there is no impact on the Physical Layers (e.g., IEEE 802.11a PHY and 802.11b PHY).

In many cases, vendors of infrastructure devices (APs and/or WSs) would like to modify their devices to provide special or enhanced functionality. However, infrastructure vendors do not have access to firmware in Network Interface Cards (NICs) implemented at the client devices and therefore can not modify firmware on these NICs. On the otherhand, client device vendors are resistant to modify their NIC firmware to make it compatible with special features offered by one particular infrastructure vendor since client device vendors want their NICs to be compatible with products from a wide variety of infrastructure vendors, especially at the basic 802.11 MAC level. Simply put, modifying the NIC firmware to suit the needs of one particular infrastructure vendor would potentially limit compatibility of that client vendor's device with infrastructure provided from other vendors.

As a result, infrastructure vendors have been very limited in their ability to provide special or enhanced functionality, to implement new operating models and features and functions, etc. For example, wireless switch vendors originally envisioned a variety of new operating models and new functionality that are not possible in access point only architectures. However, in many cases, this new functionality requires compatibility at the client device, and because client device vendors are very reluctant to modify software or hardware configurations of the NIC used in conjunction with their devices, it has been difficult for wireless switch vendors to implement enhanced, wireless switch specific features. As such, improvements provided by the wireless switch architecture have been limited to mostly network management type functions. Thus, a problem facing infrastructure or switch vendors is how to take advantage of the wireless switch architecture when the client vendors are completely uninterested in adding wireless switch specific features to their products.

### BRIEF SUMMARY

Improved techniques for communicating between a client device and an infrastructure device are provided. According to one embodiment, a WLAN system is provided that includes an infrastructure device that wirelessly communicates with a client device in IBSS mode over a pseudo-BSS/IBSS air interface. The client device includes a first WLAN Network Interface Card (NIC) and a client host system, and the infrastructure device includes a hardware interface and a host system.

The client device operates in pseudo-BSS/IBSS mode. The client host system comprises upper protocol layer modules, a client custom driver module and a WLAN NIC driver module. The client custom driver module provides pseudo BSS-like service(s) with respect to packets generated by the upper protocol layer modules to generate one or more pseudo-BSS-like packets. The WLAN NIC driver module is configured to operate in IBSS mode, and receives the pseudo-BSS-like packets from the client custom driver module. The first WLAN Network Interface Card (NIC) also operates in IBSS mode and receives the pseudo-BSS-like packets from the WLAN NIC driver module. The first WLAN NIC generates pseudo-BSS/IBSS mode packets based on the one or more pseudo-BSS-like packets, and transmits the pseudo-BSS/IBSS mode packets over the pseudo-BSS/IBSS air interface to the infrastructure device.

The hardware interface of the infrastructure device can operate in a number of different modes including a normal BSS mode, a normal IBSS mode, and a pseudo-BSS/IBSS mode. The hardware interface receives packets transmitted over air interfaces from one or more client devices including the client device. The host system of the infrastructure device comprises a packet separation driver module and an infrastructure custom driver module. The packet separation driver module receives packets from the hardware interface, separates the packets according to packet type (i.e., a normal BSS mode packet, a normal IBSS mode packet, and a pseudo-BSS/IBSS mode packet), and sends the packets to an appropriate or correct driver module based on the packet type (whether the packet type indicates a pseudo-BSS/IBSS mode packet, a normal BSS mode packet, or a normal IBSS mode packet). When the packet separation driver module receives pseudo-BSS/IBSS mode packets from the client device, the packet separation driver module determines that the packet type is a pseudo-BSS/IBSS mode packet type, and sends the pseudo-BSS/IBSS mode packets to the infrastructure custom driver module which performs one or more BSS-like services with respect to the pseudo-BSS/IBSS mode packets.

In some implementations, the custom driver modules also include enhanced functionality so that the infrastructure custom driver module can performs one or more enhanced functions with respect to the pseudo-BSS/IBSS mode packets.

Other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1A illustrates an exemplary network which includes an IP network, an infrastructure device, and a client device;

FIG. 1B is a simplified block diagram which illustrates some of the hardware components and software modules of a client device when operating in BSS mode;

FIG. 1C illustrates an exemplary network where a client device directly communicates with another client device via IBSS mode;

FIG. 1D is a simplified block diagram which illustrates some of the hardware components and software modules of a client device when operating in IBSS mode;

FIG. 2 is a data structure which illustrates a conventional IEEE 802.11 MAC data frame format;

FIG. 3 illustrates an exemplary network which includes an IP network, an infrastructure device, and a client device that wirelessly communicates with the infrastructure device using IBSS mode communication in accordance with exemplary embodiments of the present invention;

FIG. 4 is a flowchart illustrating a method for formatting an IBSS mode packet at a client device and processing the IBSS mode packet at an infrastructure device in accordance with some embodiments of the present invention; and

FIG. 5 is simplified conceptual block diagram of a WLAN which illustrates some of the hardware components and software modules of a client device and an infrastructure device in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

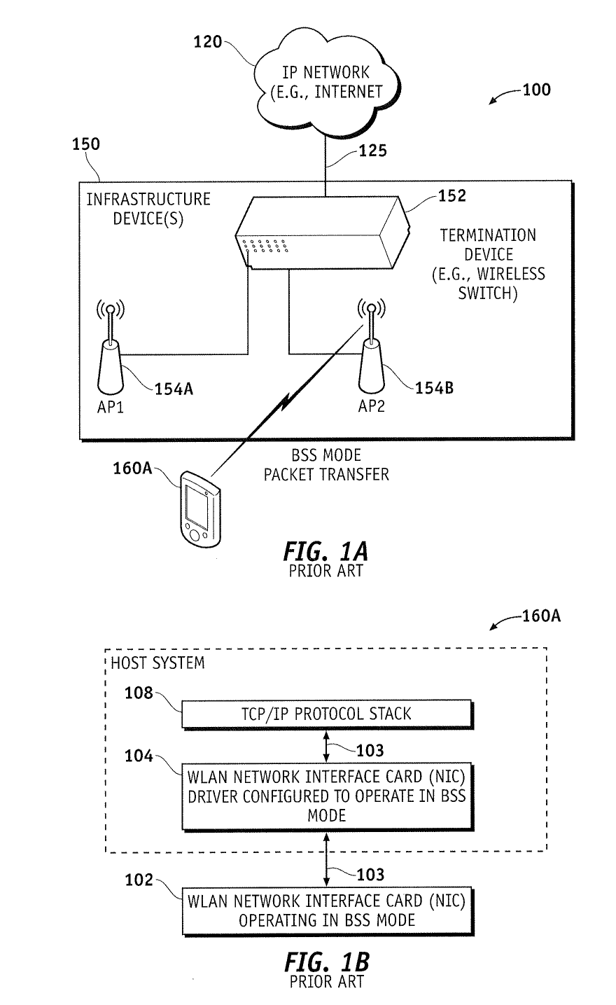

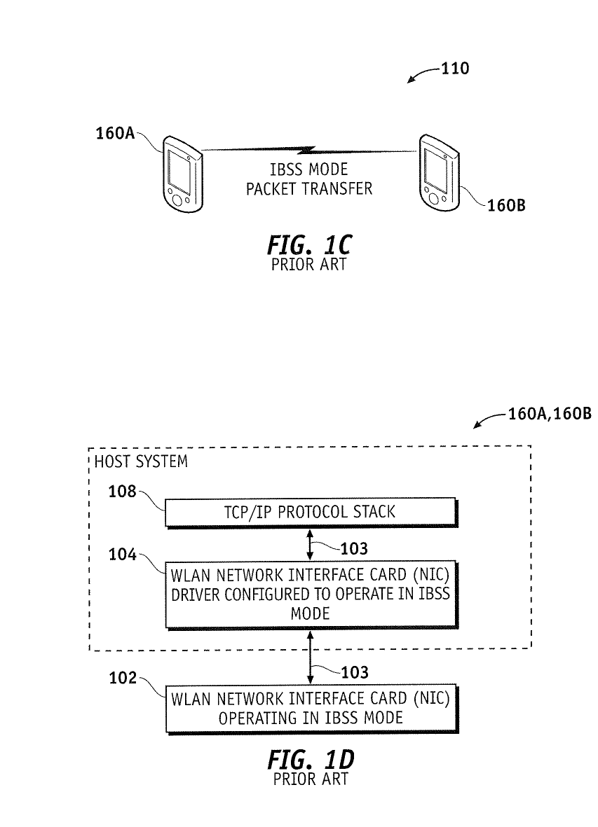

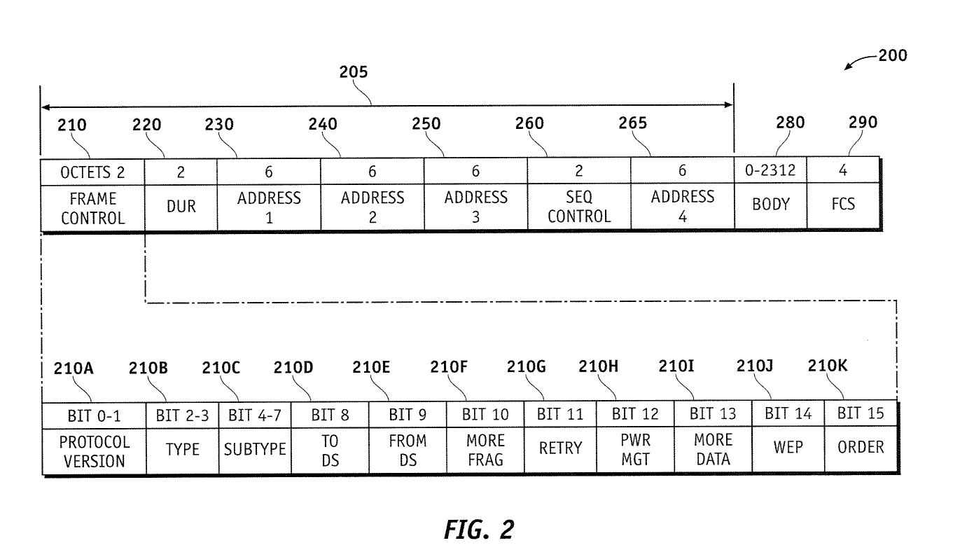

Prior to discussing example embodiments in accordance with the present invention, further details of the BSS and IBSS modes of operation discussed above will now be described with reference to FIGS. 1A through 2, and Table 1.

FIG. 1A illustrates an exemplary network 100 which includes an IP network 120, an infrastructure device 150, and a client device 160A.

A client device 160A can generally be implemented in any wireless computing device. As used herein, the term “wireless computing device” refers to any computer designed to communicate over an air interface through a wireless channel. Such wireless computing devices are “portable,” “potentially mobile” or “nomadic,” but at any particular instant can be stationary. A wireless communication device may be any one of a number of types of one-way or two-way computing devices that may receive and/or transmit information to other entities over a wireless medium. Such devices can include, but are not limited to, a hand-held or laptop devices and personal computers, tablet Personal Computers (PCs), a PC card, compact flash, personal digital assistants (PDAs), mobile telephone handsets, personal digital assistants (PDAs), laptop and portable computers with wireless communication capability, web tablets, wireless telephones, wireless headsets, pagers, instant messaging devices, MP3 players, digital cameras, etc. A wireless computing device includes a removable, wireless network interface card (NIC) (illustrated in FIG. 1B) that is sometimes referred to as a “network adapter.” The NIC can be separate from or employed within a wireless computing device that processes information. Normally, a NIC comprises a wireless transceiver, although it is contemplated that NIC may feature only receive (RX) or transmit (TX) functionality such that only a receiver or transmitter is implemented. A wireless computing device communicates with an infrastructure device (e.g., an AP) over the wireless medium in accordance with IEEE 802.11 communications protocol or another wireless networking protocol. For example, the client device 160A can communicate with the infrastructure devices 150 in accordance with any known communication standards such as those based on IEEE 802.11 (e.g., 802.11a, 802.11b, 802.11g, 802.11e, 802.11n or 802.11s) or 802.16 standards, Bluetooth, or any other packetized communication standard or packet data protocols such as TDMA (time division multiple access). As used herein the term “packet” refers to a formatted block or unit of data that is that is communicated between an origin and a destination on a packet-switched network. A packet comprises control information and user data (or payload). The control information provides data the network needs to deliver the user data, for example: source and destination addresses, error detection codes like checksums, and sequencing information. Typically, control information is found in a packet header and trailer with user data between the packet header and trailer. It should be appreciated that the term “datagram” has a similar meaning to the term “packet.” In the foregoing description, packets will be described as being either a normal or “pure” BSS mode packet, a normal or “pure” IBSS mode packet, a pseudo-BSS-like packet, or a pseudo-BSS/IBSS mode packet. The first two types of packets are known in the art. For purposes of this disclosure, two new types of packets, a pseudo-BSS-like packet and a pseudo-BSS/IBSS mode packet, are provided as will be described in greater detail below. It will be appreciated by those skilled in the art that although FIG. 1A shows an exemplary network configuration in which one client device 160A is present, in many cases tens, hundreds or thousands of client devices can be configured as part of the network at any given time.

In this particular example, the infrastructure device 150 is illustrated as including a wireless switch 152 coupled to “thin” access points 154A, B; however, in other implementations, the infrastructure device may include “thick” access points without a wireless switch, or other types of base stations.

As used herein, the term “access point (AP)” refers to a device connected to a local area network (LAN) that enables remote wireless stations to communicate with the LAN. In general, an AP is a network-capable device containing a transceiver and antenna for transmitting signals to and receiving signals from the remote client devices or stations. An AP can be either a “fat” AP with full MAC functionality, or a “thin” AP with reduced MAC functionality. A fat AP is usually implemented without a wireless switch. A fat AP is an AP with sufficient program logic and processing power to allow it to enforce policies relating to access and usage, rather than working under the supervision of a centralized controller (e.g., wireless switch). A fat AP directly serves as the point of interconnection between the WLAN and a fixed wire network and allows wireless communication devices to be quickly and easily connected to a wired LAN. In the fat AP implementations, the wireless protocol terminates at the AP. A thin AP (sometimes also referred to as an access port) is usually implemented in conjunction with a wireless switch (or other centralized controller) in which case many of the higher level MAC functions are implemented at the wireless switch instead of at the AP itself. The wireless switch configures, manages, and secures the environment for one or more thin APs, and provides a single point of administration for all thin APs it controls. Regardless of the implementation, each AP can serve multiple users within a defined network area. In one embodiment, the access points may be access points that comply with the IEEE 802.11 Standard or other wireless local area network (WLAN) Standards, a Bluetooth access point, or the like.

As will be appreciated by those skilled in the art, in either a fat AP or a thin AP configuration, the coverage of one access point (AP) is called a Basic Service Set (BSS), and each BSS is identified by a basic service set identifier (BSSID) that is broadcast by the AP in a beacon message to advertise its SSID or “network name.” The APs 154A, B control the client devices (STAs) within its BSS. In infrastructure mode, groups of BSSs can be connected together with the use of a backbone network and form a network called an Extended Service Set (ESS). An Extended Service Set (ESS) is a set of one or more interconnected BSSs, where the APs 154A, B communicate among themselves to forward traffic from one BSS to another, and to facilitate the movement of a client device 160A from one BSS (e.g., the BSS defined by AP1 154A) to another (e.g., the BSS defined by AP2 154B). An ESS appears as a single network to the logical link control layer at any client device associated with one of those BSSs.

The wireless switch 152 is a network entity which is coupled to and controls at least one access point (AP) (and possibly multiple APs). The wireless switch 352 serves as a termination point for a wireless protocol (e.g., the IEEE 802.11 protocol), and hence the term “wireless” switch. When a wireless switch architecture is implemented, client device(s) communicate with an AP over the air via wireless packets (e.g., IEEE 802.11 data packets), and the AP passes the wireless packets to a wireless switch over a wire between that connects the wireless switch and the AP. In other words, the wireless switch communicates wireless packets (e.g., IEEE 802.11 data packets) with the AP. For instance, in the context of IEEE 802.11 networks, a wireless switch decapsulates inbound IEEE 802.11 data packets received from client device via an access point into IP packets, and converts/encapsulates outbound IP packets destined for a client device into IEEE 802.11 data packets before passing them on to an AP for transmission to the client device. This way, the wireless switch can determine information including, but not limited to, Received Signal Strength Indicator (RSSI), locationing information, in-activity timers and a list of active clients. In addition to IP mobility functions (e.g., IEEE 802.11), a wireless switch (WS) also performs a number of additional functions including, for example, management of APs and MHs, locationing, Wireless Intrusion Detection System (IDS), security (IEEE 802.11i, IPsec VPN, SSL VPNs).

In FIG. 1A, the client device 160A and access points 154A, B operate according to an IEEE 802.11 wireless LAN (WLAN) BSS mode or “network configuration.” Throughout this document, communications between a client device and an access point that occur during BSS mode are referred to as “BSS mode communications” and involve the communication of at least one BSS mode packet. In this regard, a normal or “pure” BSS mode packet refers to a packet transmitted during communications between a client device and an access point (AP) or access port in a BSS mode network. Per the IEEE 802.11 standards, the client device 160A communicates with access point (AP2) 154 only after the device 160 has associated with an AP 154, performed authentication, etc. As appreciated by those skilled in the art, these authentication and association procedures are complex and involve a time consuming series of operations. Once the client device 160A has been associated and authenticated with the AP2 154B, any data communicated from the client device 160A to the infrastructure must pass through an AP2 154B, and vice-versa.

FIG. 1B is a simplified block diagram which illustrates some of the hardware components and software modules of a client device 160A when operating in BSS mode. As illustrated in FIG. 1B, the client device 160A includes a WLAN Network Interface Card (NIC) 102 configured to operate in BSS mode, and a host system that includes, among other things, a WLAN NIC driver 104, which is configured to operate in BSS mode, and a Transmission Control Protocol/Internet Protocol (TCP/IP) stack 108. The WLAN NIC driver 104 is communicatively coupled to the TCP/IP stack 108 and to the WLAN NIC 102 via bus 103. The WLAN NIC driver 104 is a computer program module that allows higher-level computer program modules in the TCP/IP stack 108 to interact with the WLAN NIC 102. The WLAN NIC driver 104 communicates with the WLAN NIC 102 through the computer bus or communications subsystem 103 to which the WLAN NIC 102 is connected. When a calling program invokes a routine in the WLAN NIC driver 104, the WLAN NIC driver 104 issues commands to the WLAN NIC 102. When the WLAN NIC 102 sends data back to the WLAN NIC driver 104, the WLAN NIC driver 104 may invoke routines in the original calling program. The WLAN NIC driver 104 is hardware-dependent and operating-system (OS) specific.

FIG. 2 is a data structure which illustrates a conventional IEEE 802.11 MAC data frame format 200. In the IEEE 802.11 standard, the MAC data frame format 200 is sometimes referred to as a MAC protocol data unit (MPDU). The MAC data frame format 200 comprises a MAC header 205, a frame body field 280 and a frame check sum (FCS) field 290.

The MAC data header 205 comprises a frame control field 210, a duration field 220, address fields 230, 240, 250, 265, and a sequence control field 260. The Frame Control field 210 includes a protocol version sub-field 210A, a type sub-field 210B, a subtype sub-field 210C, a ToDS bit 210D, a FromDS bit 210E, a more fragment bit 210F, a retry bit 210G, a power management bit 210H, a more data bit 210I, a WEP bit 210J and an order bit 210K. The body field 280 comprises data or “payload” information. The FCS field 290 contains a cyclic redundancy check to detect errors in the frame which may have occurred during transmission. The various fields and subfields are well-known in the art and will not be described in detail herein.

Table 1 illustrates contents of the ToDS bit 210D, FromDS bit 210E and address fields 230, 240, 250, 265 in each of the different modes of operation. In Table 1, the following acronyms are used: Receiver Address (RA), Transmitter Address (TA), Destination Address (DA) and Sender Address (SA). The RA is the next MAC address or “next hop address,” to which the frame is sent over the wireless medium, the TA is the MAC address of the station that transmits the frame to the wireless medium, the DA is the final destination MAC address for the data frame, and the SA is the originating MAC address of the data frame.

TABLE 1

| | ToDS | FromDS | Address | Address | Address | Address |
|---|---|---|---|---|---|---|
| Mode | bit | bit | 1 | 2 | 3 | 4 |
| IBSS (data | 0 | 0 | DA | SA | BSSID | N/A |
| frame from | | | | | | |
| STA to | | | | | | |
| STA) | | | | | | |
| BSS data | 0 | 1 | DA | BSSID | SA | N/A |
| frame from | | | | | | |
| AP to STA | | | | | | |
| BSS data | 1 | 0 | BSSID | SA | DA | N/A |
| frame from | | | | | | |
| STA to AP | | | | | | |
| WDS from | 1 | 1 | RA | TA | DA | SA |
| AP to AP | | | | | | |

In BSS mode communications illustrated in FIG. 1A, when the AP 154 is preparing the MAC data frame for transmission to the client device 160A, the AP 154 sets the ToDS bit 210D to zero (0) and sets the FromDS bit 210E is set to one (1). Similarly, when the client device 160A is preparing a MAC data frame for transmission to the AP 154, the client device 160A sets the ToDS bit 210D to one (1) and the FromDS bit 210E to zero (0). Although not illustrated in FIG. 2, it will be appreciated by those skilled in the art, that before any MAC data frame is transmitted over the wireless medium, a physical layer convergence procedure (PLCP) preamble (not shown), a PLCP header, and a CRC are appended to the MAC data frame to generate a physical (PHY) layer frame that is transmitted over the wireless medium.

In contrast, IBSS mode communications are used for peer-to-peer communications between two or more client devices. Throughout this document, communications that occur during IBSS mode are referred to as “IBSS mode communications” and involve the communication of at least one IBSS mode packet. A normal or “pure” IBSS mode packet refers to a packet transmitted during direct, peer-to-peer communications between two or more client devices (STAs) in an IBSS mode network without implicating an infrastructure device. FIG. 1C illustrates an exemplary network 110 where a client device 160A directly communicates with another client device 160B via IBSS mode. As mentioned above, in IBSS mode, the client devices 160A, 160B can exchange data directly with one another without the use of infrastructure so long as the client devices 160A, 160B are within communication range of one another.

To set up an IBSS mode network, the client device 160A seeks out other client devices that are members of a specific service set based on Service Set Identifiers (SSIDs) the client device 160A receives. If the client device 160A does not locate any other client devices with the desired SSID, it will select a wireless channel and attempt to start its own IBSS network by sending beacons, which are needed to maintain synchronization among the client devices. Other client devices that receive one of these beacons can join the IBSS network by accepting the IBSS parameters (e.g., beacon interval) found in the beacon frame. For instance, client device 160B listens for beacons and when it receives the beacon transmitted from client device 160A on a particular wireless channel (a pre-defined, standardized frequency band), client device 160B can select that channel and join the IBSS network. In comparison to BSS mode, setting up an IBSS network between the client devices 160A, 160B is relatively simple since no association and authentication is required between nodes communicating in IBSS mode. In fact, in regular IBSS mode there is no association/authentication, encryption key setup, etc.

FIG. 1D is a simplified block diagram which illustrates some of the hardware components and software modules of client devices 160A, 160B when operating in IBSS mode. As illustrated in FIG. 1D, each client device 160A, 160B includes a WLAN Network Interface Card (NIC) 102 configured to operate in IBSS mode, a WLAN NIC driver 104 that is configured to operate in IBSS mode, and a Transmission Control Protocol/Internet Protocol (TCP/IP) stack 108. As above, the WLAN NIC driver 104 is coupled to the TCP/IP stack 108 and to the WLAN NIC 102 via bus 103 to allow the TCP/IP stack 108 to interact with the WLAN NIC 102. It should be noted that all NICs and associated network drivers must be capable of operating IBSS mode to the extent that they comply with the IEEE 802.11 standards.

Once the IBSS network is set up, the NICs of client devices 160A, 160B can communicate directly with each other. As illustrated in Table 1, the transmitting client device sets both the ToDS bit 210D and the FromDS bit 210E to zero (0). It will be appreciated that if an AP (not illustrated in FIG. 1C) inadvertently receives an IBSS data frame transmitted from a client device that is communicating in IBSS mode, the MAC layer module of the AP will discard the IBSS data frame since it regards the IBSS data frame as being destined to a client device or “BSS STA.”

Thus, client devices 160A, B can operate in accordance with BSS mode when infrastructure devices are present, or can operate in accordance with IBSS mode in when infrastructure devices are not present. Notwithstanding these advances, it would be desirable to provide alternative packet transfer mechanisms for communicating information between client devices and infrastructure devices. It would also be desirable if such alternative packet transfer mechanisms can allow infrastructure vendors to implement special or enhanced functionality despite the fact that the infrastructure vendor lacks access or ability to modify NIC firmware of client devices.

As will be described below, the disclosed embodiments can provide methods for communicating information between client devices and infrastructure devices, which can allow infrastructure vendors to implement special or enhanced functionality without modifying NIC firmware of client devices. In one implementation, the infrastructure device may comprise an access point, and in some implementations, a wireless switch coupled to the access point. According to one embodiment, the wireless client device includes a Network Interface Card (NIC) that is configured to operate in IBSS mode, and a host system communicatively coupled to the NIC. The host system includes upper protocol layer modules, a Network Interface Card (NIC) driver module configured to operate in IBSS mode, and another driver module that interfaces between the NIC driver module and the upper protocol layer modules, the other driver module being configured to provide a BSS-like service to the NIC driver module and the upper protocol layer modules. The wireless client device formats data to be transmitted to the infrastructure device in accordance with the IBSS packet transfer mode to generate one or more IBSS mode packet(s). In one implementation, each IBSS mode packet comprises: a frame control field comprising a ToDS bit that is set to logical zero (0), and a FromDS bit that is set to logical zero (0). Each IBSS mode packet may also include addressing information that includes a first/receiver address field that is set to a destination address of the IBSS mode packet; a second address field that is set to a source address of the infrastructure device; and a third address field that specifies a Basic Service Set ID (BSSID). The wireless client device can transmit the IBSS mode packet(s) to the infrastructure device.

Upon receiving each IBSS mode packet, the infrastructure device can process the IBSS mode packet by reading a ToDS bit and a FromDS bit in each packet received by the infrastructure device. When the ToDS bit and the FromDS bit are both set to zero, the infrastructure device determines that the received packets is an IBSS mode packet, and performs further processing on the IBSS mode packet even though the ToDS bit and the FromDS bit are both set to zero. Thus, IBSS mode can be used to construct an IEEE 802.11 compliant network that takes advantage of the wireless switch architecture.

The infrastructure device can also transmit IBSS mode packet(s) to the wireless client device.

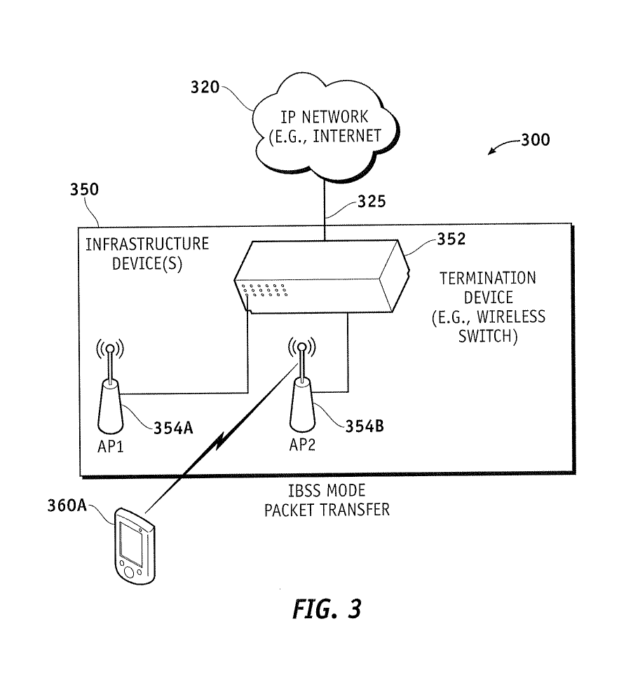

Embodiments of the present invention will now be described with reference to FIGS. 3 through 5.

Simplified Client/Infrastructure Communications

FIG. 3 illustrates an exemplary network 300 which includes an IP network 320, an infrastructure device 350, and a client device 360 that wirelessly communicates with the infrastructure device 350 using IBSS mode communication in accordance with exemplary embodiments of the present invention. The IP network 320 which may comprise, for example, the Internet or an intranet. In this particular embodiment, the infrastructure device 350 is implemented as access points 354A, B coupled to a wireless switch 352 that controls the access points 354A, B.

As described above with reference to FIGS. 1A and 1B, the client device 360A and the infrastructure device 350 would normally communicate with each other over their respective BSS interfaces only. Communications in BSS mode are relatively complex since a client device can send a packet to an AP only after the client device has associated and authenticated with that AP. By contrast, in IBSS mode, a client device can send packets to any other device without going through a time-consuming association and authentication process. Moreover, data communications in IBSS mode are completely stateless or raw. Notably, any IEEE 802.11 compatible client device includes a NIC which has both a BSS interface with high-level functionality and an IBSS interface with low-level IBSS functionality. Moreover, every major operating system, defines an interface for IBSS.

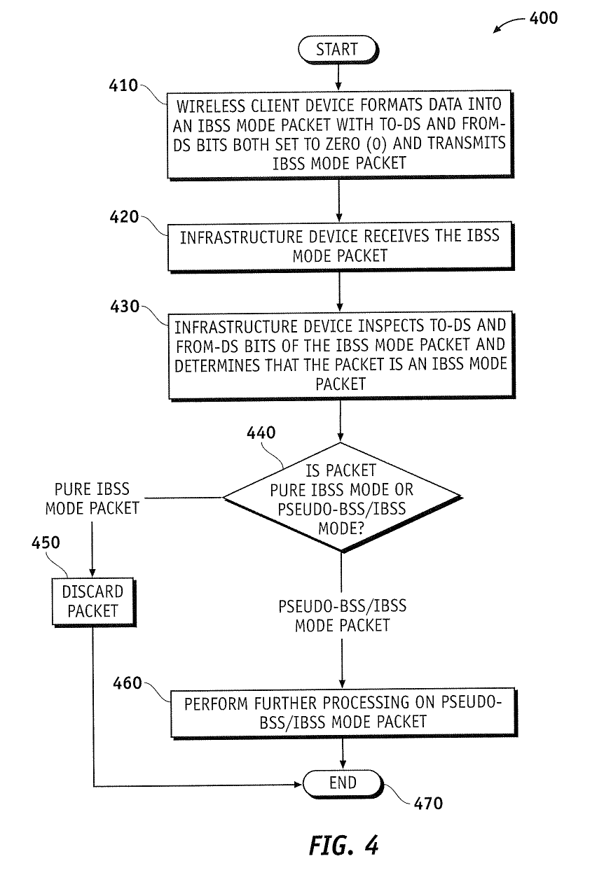

In accordance with embodiments of the present invention, which are described in detail below with reference to FIG. 4, techniques are provided which allow the client device 360A and the infrastructure device 350 to communicate with each other in IBSS mode. Because all IEEE 802.11-compliant NICs are required to support IBSS mode, the client device 360A can communicate information with the infrastructure device 354 (e.g., an access point (AP) and/or wireless switch) using IBSS mode by modifying the conventional operation of the client device 360A and the infrastructure device 350. By using IBSS mode communications between the client device 360A and the infrastructure device 354, the complexity associated with BSS mode communications can be eliminated.

Example IBSS Mode Communication Between Client and Infrastructure

During communications between a client device 360A and an infrastructure device 354, the NIC of the client device 360A operates in IBSS mode thereby allowing all of the normal BSS processing associated with communications between the client device 360A and infrastructure device 354 to be eliminated. As such, the client device 360A and the infrastructure device 354 can operate or communicate with each other without being bound by constraints or limitations normally imposed by or associated with conventional BSS mode communications (i.e., in a conventional IEEE 802.11 BSS network configuration). For instance, when packets are transmitted from the client device 360A to an infrastructure device 354 in IBSS mode, all high-level MAC functionality is disabled and the client NIC operating in IBSS mode (instead of BSS mode) communicates nearly “raw” data packets to the infrastructure device 354. Therefore, the client device 360A and infrastructure device 354 can communicate with much less overhead. Moreover, when the client device 360A communicates in IBSS mode, and the client device 360A does not need to associate and/or authenticate with the AP, whereas when operating in regular BSS mode, a client device 360A can not send a “BSS mode” packet to the infrastructure device 354 until the client device 360A associates/authenticates with the infrastructure device 354.

To enable IBSS mode communication between the client device 360A and infrastructure device 354, the normal operation of the infrastructure device 354 can be modified so that the infrastructure device 354 does not simply discard IBSS mode packets upon receipt.

FIG. 4 is a flowchart illustrating a method 400 for formatting an IBSS mode packet at a client device and processing the IBSS mode packet at an infrastructure device 354 in accordance with some embodiments of the present invention. Method 400 will be described with reference to FIG. 3.

The method 400 starts at step 410, where a NIC of transmitting client device 360A formats a data as an IBSS mode packet for transmission in IBSS mode. In the disclosed embodiments, the NIC of client device 360A performs only basic packet formatting functions to the data, and other high-level functionality of the NIC 302 (e.g., functionality related to roaming, association, authentication, encryption, power saving) is not performed or is “disabled” when operating in IBSS mode. For instance, the NIC simply assumes that any destination address provided from some higher protocol layer has meaning and that another device (e.g., another client device, AP, wireless switch) will respond to the IBSS mode packets transmitted by the NIC. When formatting the data, the NIC of client device 360A sets both the ToDS bit 210D and the FromDS bit 210E to zero (0) to indicate that the packet is an IBSS-formatted data frame.

At step 420, the infrastructure device 354 receives the IBSS mode packet (without knowing that it is an IBSS mode packet), and at step 430, the infrastructure device 354 inspects the ToDS bit 210D and the FromDS bit 210E. The infrastructure device 354 determines that both bits are set to zero (0), and therefore determines that the data is an IBSS mode packet.

At step 440, the infrastructure device 354 determines whether the IBSS mode packet is a “pure” IBSS mode packet or a pseudo-BSS/IBSS mode packet. As used herein the term “a pseudo-BSS/IBSS mode packet” refers to a packet that is processed in accordance with one or more BSS-like services and includes some characteristics of a normal or “pure” BSS mode packet, but differs in that it is not communicated by a WLAN NIC operating in normal BSS mode. In some implementations, a pseudo-BSS/IBSS mode packet is also processed in accordance with one or more enhanced functions by a custom driver module. A pseudo-BSS/IBSS mode packet is a pseudo-BSS-like packet that is which is subsequently processed by a WLAN NIC driver module and WLAN NIC operating in normal IBSS mode, and transmitted by the WLAN NIC operating in IBSS mode over an air interface to an infrastructure device, and then subsequently processed at the infrastructure device.

When the infrastructure device 354 determines that the IBSS mode packet is a pure IBSS mode packet, the method 400 proceeds to step 450 where the infrastructure device 354 may discard the pure IBSS mode packet, and the method 400 proceeds to step 470 where the method 400 ends.

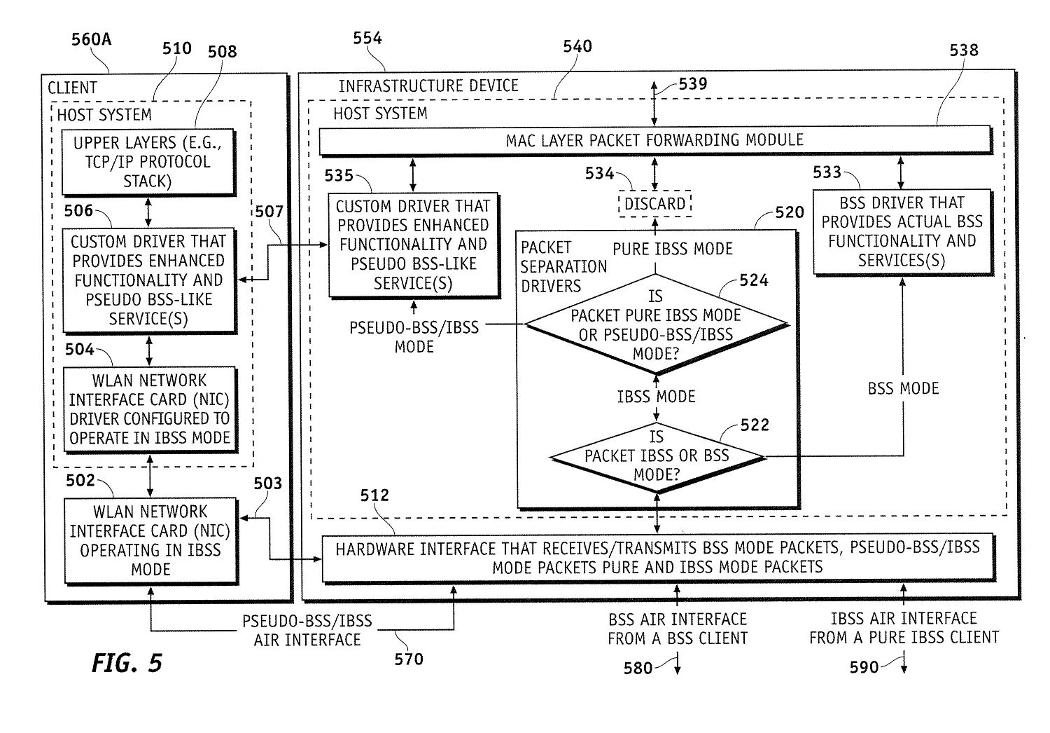

When the infrastructure device 354 determines that the IBSS mode packet is a pseudo-BSS/IBSS mode packet, the infrastructure device 354 is modified to allow for communications with an IBSS interface of NIC, and the infrastructure device 354 performs further processing of the pseudo-BSS/IBSS mode packet even though it appears to be destined to a client device or “IBSS station (STA).” In essence, the infrastructure device 354 creates a pseudo-BSS network configuration. The method 400 ends at step 470. As described below with reference to FIG. 5, the infrastructure device 354 can further process of the pseudo-BSS/IBSS mode packet by forwarding pseudo-BSS/IBSS mode packet to a custom driver running on the infrastructure device 354. Although not illustrated in FIG. 4, when the infrastructure device is an AP implemented in conjunction with a wireless switch that controls one or more access points (APs), the AP removes the IBSS header from the data frame and forwards the remaining IEEE 802.11 data frame to the wireless switch for further processing.

By contrast, when a packet is transmitted from the infrastructure device 354 to the client device 360A, all addressing information needed for IBSS mode would be present the in the 802.11 packets sent from the infrastructure device 354. The client device 360A receives an IBSS packet, realizes that it is operating in IBSS mode, and then performs processing as it would with any IBSS communication. Because the standard BSS mode of operation is effectively disabled at the client device 360A, the client device 360A does not need to perform all of the additional functions normally associated with BSS mode operation. The NIC simply sends and receives packets, and there is no BSS state information associated with the IBSS mode communications. Thus, the NIC at the client device 360A simply receives the IBSS packet from the infrastructure devices 354 and performs relatively limited processing on the IBSS packet before passing the IBSS packet to upper protocol layers of the host system.

Custom Driver

FIG. 5 is simplified conceptual block diagram of a WLAN which illustrates some of the hardware components and software modules of a client device 560A and an infrastructure device 554 in accordance with an exemplary embodiment of the present invention. The client device 560A and infrastructure device 554 are illustrated as being divided into a number of layers or modules, and within each layer, one or more entities implement its functionality. Each entity interacts directly with the layer immediately beneath it, and provides services for use by the layer above it. In FIG. 5, vertical arrows represent interfaces between entities (e.g., blocks) over which information is communicated between entities. As will be appreciated by those skilled in the art, an entity/layer/module 502, 506 in the client device 560A can logically communicate with a corresponding peer entity/layer/module 512, 535 in the infrastructure device 554 as indicated by arrows 503, 507, where arrows 503, 507 represent the protocols for each layer. The client device 560A and the infrastructure device 554 physically communicate with each other over-the-air (OTA) as indicated by arrow 570, where arrow 570 represents a pseudo-BSS/IBSS physical layer or air interface. As such, when the client device 560A operates in pseudo-BSS/IBSS mode, the client device 560A can wirelessly communicate with the infrastructure device 554 in IBSS mode over a pseudo-BSS/IBSS air interface 570. Likewise, the infrastructure device 554 physically communicates with other client devices (not illustrated) over-the-air (OTA) as indicated by arrow 580, where arrow 580 represents a BSS physical layer or air interface with a BSS client (not illustrated) operating in BSS mode, and as indicated by arrow 590, where arrow 590 represents an IBSS physical layer or air interface with an IBSS client (not illustrated) operating in “pure” IBSS mode.

In this embodiment, the client device 560A is illustrated as including a WLAN Network Interface Card (NIC) 502 operating in IBSS mode, and a client host system 510. The host system 510 includes one or more upper protocol layer modules 508, a custom driver 506, and a WLAN NIC driver 504 that is configured to operate in IBSS mode.

The custom driver 506 provides pseudo BSS-like services and/or enhanced functionality with respect to packets generated by the upper protocol layer modules 508 to generate pseudo-BSS-like packets. As used herein the term “a pseudo-BSS-like packet” refers to a packet that is processed in accordance with one or more BSS-like services and includes some characteristics of a normal or “pure” BSS mode packet, but differs in that it is not communicated by a WLAN NIC operating in normal BSS mode. Examples of these BSS-like services provided to the upper layers 508 include one or more IEEE 802.11 standard BSS mode network services and functionality including: an association service, a disassociation service, a re-association service, a distribution service, an integration service, an authentication service, a de-authentication service, a confidentiality/privacy service, a data delivery service, a transmit power control service, a dynamic frequency selection service, and a mobility support service. As will be described below, by implementing this custom driver 506 in conjunction with IBSS mode communications, infrastructure vendors can implement one or more of the IEEE 802.11 standard BSS mode network services or functionality (i.e., referred to as “BSS-like services” in this mode since they are applied to a different type of packet, a pseudo-BSS/IBSS mode packet), as well as enhanced functionality that is not described in IEEE 802.11 standards (or that extends functionality described in IEEE 802.11 standards) some examples of which are described below.

WLAN NIC driver 504, which operates in IBSS mode, receives pseudo-BSS-like packets from the custom driver module 506. When a calling program invokes a routine in the WLAN NIC driver 504, the WLAN NIC driver 504 issues commands to the WLAN NIC 502. When the WLAN NIC 502 sends data back to the WLAN NIC driver 504, the WLAN NIC driver 504 may invoke routines in the original calling program. The WLAN NIC driver 504 allows the custom driver 506 (and higher-level computer programs in the upper layers 508) to interact with the WLAN NIC 502, and the custom driver 506 interacts with the WLAN NIC 502 via WLAN NIC driver 504.

The WLAN Network Interface Card (NIC) 502 receives pseudo-BSS-like packets from the WLAN NIC driver module 504, generates pseudo-BSS/IBSS mode packets based on the pseudo-BSS-like packets, and transmits the pseudo-BSS/IBSS mode packets OTA via interface 570 to the infrastructure device 554.

The infrastructure device 554 includes a hardware interface module 512 and a host system 540.

The hardware interface 512 can operate one or more of pseudo-BSS/IBSS mode, normal BSS mode, and normal IBSS mode, and is configured to receive packets transmitted over air interfaces from one or more client devices including the client device 560A. The hardware interface module 512 is capable of communicating (i.e., transmitting and/or receiving) packets including normal (or “pure”) BSS mode packets, normal (or “pure”) IBSS mode packets, and pseudo-BSS/IBSS mode packets. To explain further, the hardware interface module 512 includes logical interfaces capable of operating in IBSS mode, in BSS mode, and/or in pseudo-BSS/IBSS mode. The hardware interface module 512 is usually associated with a single MAC address, and the “logical” interfaces are also associated with this MAC address (i.e., are not physically separate entities). As noted above, the hardware interface module 512 communicates over-the-air (OTA) with the WLAN NIC 502 of the client device 560A (operating in IBSS mode) over the pseudo-BSS/IBSS air interface 570, with a BSS client device (not illustrated) operating in pure BSS mode over the BSS air interface 580, and with an IBSS client device (not illustrated) over the IBSS air interface 590. As such, the infrastructure device 554 is capable of concurrently operating in any one of three modes (i.e., pseudo-BSS/IBSS mode, normal BSS mode, and normal IBSS mode) at any given time.

The host system 540 includes a packet separation driver module 520, a BSS driver module 533 that is configured to operate in BSS mode, an optional IBSS packet discard driver module 534, a customer driver module 535 that is configured to operate in pseudo-BSS/IBSS mode, a MAC layer packet forwarding module 538, and network interfaces 539 (e.g., wired network interface, pure BSS network interface or pseudo-BSS/IBSS interface).

When the hardware interface 512 receives packets over an air interface 570, 580, 590, and communicates the packets to the packet separation driver module 520. The packet separation driver module 520 determines whether a packet received from the hardware interface 512 is a pseudo-BSS/IBSS mode packet (e.g., transmitted from the WLAN NIC 502 of the client device 560A over the pseudo-BSS/IBSS air interface 570), a normal BSS mode packet (e.g., transmitted from a pure BSS client over interface 580), or a normal IBSS mode packet (e.g., transmitted from a pure IBSS client over interface 590). In one embodiment, the packet separation driver module 520 includes two sub-modules 522, 524 for separating packets according to packet type (BSS mode packet, pure IBSS mode packet, pseudo-BSS/IBSS mode packet) and providing them to a correct driver module 533, 534, 535.

To explain further, BSS/IBSS differentiator module 522 differentiates between IBSS mode packets and BSS mode packets. When BSS/IBSS differentiator module 522 determines that a packet provided from hardware interface 512 is a normal or “pure” BSS mode packet, the BSS/IBSS differentiator module 522 sends the BSS mode packet to BSS driver module 533. The BSS driver module 533 provides actual IEEE 802.11 BSS mode functionality and services including IEEE 802.11 standard BSS mode network services and functionality including: an association service, a disassociation service, a reassociation service, a distribution service, an integration service, an authentication service, a deauthentication service, a confidentiality/privacy service, a data delivery service, a transmit power control service, a dynamic frequency selection service, and a mobility support service. After performing one or more IEEE 802.11 standard BSS mode network services and functionality to the packet, the BSS driver module 533 sends the resultant BSS mode packet to the MAC layer packet forwarding module 538. The MAC layer packet forwarding module 538 that routes packets to a correct network interface 539 (e.g., wired Ethernet network interface, pure IEEE 802.11 BSS network interface or pseudo-BSS/IBSS interface) for communication to the appropriate entity.

When the BSS/IBSS differentiator module 522 determines that a packet provided from hardware interface 512 an IBSS mode packet, the BSS/IBSS differentiator module 522 sends the IBSS mode packet to the pseudo-BSS/IBSS differentiator module 524, which further differentiates between “pure” or normal IBSS mode packets and pseudo-BSS/IBSS mode packets.

When the pseudo-BSS/IBSS differentiator module 524 determines that the IBSS mode packet is a pure/normal IBSS mode packet, then the pseudo-BSS/IBSS differentiator module 524 sends the pure/normal IBSS mode packet to either module 534 where the pure/normal IBSS mode packet is discarded or sends the pure/normal IBSS mode packet to the MAC layer packet forwarding module 538.

When the pseudo-BSS/IBSS differentiator module 524 determines that the IBSS mode packet is a pseudo-BSS/IBSS mode packet, then the pseudo-BSS/IBSS differentiator module 524 sends the pseudo-BSS/IBSS mode packet to custom driver module 535 for further processing. Similar to the host system 510 of the client device 560A, the host system 540 of the infrastructure device 554 also includes a custom driver module 535 that corresponds to the custom driver module 506 of the client device 560A. The custom driver module 535 receives pseudo-BSS/IBSS mode packets from the packet separation driver module 520 and performs one or more BSS-like services, and possibly other enhanced functions, with respect to the pseudo-BSS/IBSS mode packets. In other words, the custom driver module 535 provides BSS-like services and/or enhanced functionality with respect to the pseudo-BSS/IBSS mode packet before passing the pseudo-BSS/IBSS mode packet to the MAC layer packet forwarding module 538.

Custom Driver is Transparent and Does Not Impact Functionality Required by IEEE 802.11 Standards

The custom driver 506 is located or inserted at the host 510 operating system above the conventional WLAN NIC driver 504, which is configured to operate in IBSS mode, and below the upper protocol layers 508 (e.g., the TCP/IP stack). As such, the custom driver module 506 operates transparently with respect to the one or more upper protocol layer modules 508 operating above the custom driver module 506 and with respect to the WLAN NIC driver module 504 operating below the custom driver module 506 such that the upper protocol layer modules 508 anticipate communication with the WLAN NIC driver module 504, and the WLAN NIC driver module 504 anticipates communication with the upper protocol layer modules 508. To explain further, from the perspective of the upper layers 508 running above it, the custom driver 506 is transparent since the upper layers 508 (e.g., TCP/IP protocol stack) simply “see” the WLAN NIC driver 504 that is configured to operate in IBSS mode and “think” that they are still communicating with the WLAN NIC driver 504. However, as packets pass down to protocol stack, the custom driver 506 provides enhanced functionality and modifies the packets accordingly before passing them down to the NIC driver 504. Likewise, from the perspective of the WLAN NIC driver 504 that is configured to operate in IBSS mode, the custom driver 506 operates transparently. From the perspective of the WLAN NIC driver 504, the WLAN NIC driver 504 simply thinks its communicating packets with the upper layers 508 (e.g., the TCP/IP protocol stack) and does not realize that there is the intermediate, custom driver 506 is operating between the two. Because the custom driver 506 is transparent to the other layers, enhanced functionality provided by custom driver 506 does not impact/violate any of the functionality required by the IEEE 802.11 standards. The client device will still fully conform to all wireless and wired network standards, operating system (OS) driver interfaces and APIs.

Custom Driver Allows Infrastructure Device Vendors To Provide Enhanced Functionality at Client Device

By adding the custom driver 506 to the host system 510 of the client device 560A, infrastructure vendors (e.g., wireless switch vendors) can make any client device 560A compatible with the enhanced functionality the vendor chooses to provide at the infrastructure device 554 via custom driver 535. Enhanced or specialized networking functions implemented at the client device 560A do not alter or change the hardware or software on the NIC 502, and infrastructure vendors can modify the operation of the client device 560A without having access to the source code of the NIC 502. Enhanced or specialized networking functions implemented at the client device 560A are supported by the custom driver 535 of the infrastructure device 554 and in some cases are extensions of IEEE 802.11 standard BSS mode network services and functions.

The custom driver 506 of the host system 510 can emulate a BSS mode environment in a way that is transparent to the NIC 502 by providing a BSS-like services to the upper layers 508 and receiving service from the WLAN NIC driver 504 below it. The custom driver 506 can mimic BSS code already present in client device's NIC 502 to create appearance of a wireless BSS mode connection. A working infrastructure or “BSS” mode network is implemented on top of an IBSS packet transfer mechanism (i.e., client device operating in IBSS mode). As such, infrastructure vendors can still operate on an IEEE 802.11 BSS-like network without being bound by constraints of IEEE 802.11 BSS mode (e.g., the limitations of the IEEE 802.11 MAC protocol). In short, the infrastructure vendor has a blank slate upon which the vendor can build a more optimal WLAN.

The wireless switch architecture enables many enhancements to conventional IEEE 802.11 networks. However, in many cases it is difficult if not impossible to implement these enhancements since there is no way to provide necessary software at the client device. In many cases, for example, it is not possible to modify the NIC 504 firmware at the client device 560A without violating the IEEE 802.11 standards. The custom driver 506 described above provides a mechanism for adding the software necessary to support these enhancements provided at the infrastructure device 540 via custom driver 535 without impacting regular IEEE 802.11 operation of the NIC 502.

Some specific examples of enhanced specialized networking functionality that can be provided via custom drivers 506, 535 will now be described. The examples of enhanced functionality that follow are only a few possible examples of functionality that can be enabled by the custom drivers 506, 535. Many additional enhancements are also possible using the custom drivers 506, 535.

Exemplary Enhancements Provided by Custom Driver Modules

Low Latency Roaming Between Access Points

Conventional IEEE 802.11 networks handle roaming using a multi-step process that involves an authentication process between the client device and access point, an association process between the client device and access point, and key exchange process between the client device and access point. First the client device must authenticate to the access point. The authentication process typically involves a three or four packet exchange to prove that the client device is indeed who they say they are. Once authenticated, the client device sends association request packet to access point indicating that client device would like to associate with and roam to the access point. In some implementations where privacy/confidentiality mechanisms are implemented, a security key exchange takes place where the client device and access point exchange information needed to derive security keys and then derive the security keys. This typically involves a four to six packet exchange. In other implementations where privacy/confidentiality mechanisms are not implemented, if the access point accepts the association request, then the client device can communicate with the access point. In some implementations, a client device can roam from one access point to another using techniques specified in the IEEE 802.11r standard. The IEEE 802.11r standard specifies techniques for fast BSS transitions with fast handoffs from one access point to another access point to help support applications like voice (voice-over-IP (VoIP)) and video-over-IP. Under 802.11r, client devices can use the current access point as a conduit to other access points, allowing the client device to minimize disruptions caused by changing channels. In particular, IEEE 802.11r refines the transition process as a mobile client device roams or moves between access point by allowing the client device to establish a security and QoS state at a new access point before making a transition to help reduce changes of lost connectivity and application disruption.

In wireless switch architectures, the client device communicates with and authenticates to the wireless switch. Moreover, the wireless switch also handles privacy/confidentiality functions. As such, when wireless switch architectures are utilized, there is no reason to re-authenticate/re-key when the client device roams from one access point to another access point.

In implementations of the disclosed embodiments where the client device is communicating with the wireless switch, the client device has already undergone the authentication, association, and/or performed a key exchange with the wireless switch. Therefore, if the client device would like to roam to another access point (connected to the same wireless switch), then the client device can simply send a packet to the wireless switch which indicates that the client device would like to roam to the new access point. If the wireless switch approves the client device's roam request, the wireless switch sends back a roaming authorization packet, and the roaming process is complete without the need for authentication, association, and/or a key exchange between the client device and the new access point. In contrast to the normal IEEE 802.11 roaming process which can take seconds, roaming in accordance with embodiments of the present invention involves at most a simple two packet exchange that takes only milliseconds at most and in some cases one millisecond or less depending on traffic at the wireless switch. In other implementations, a roam can be performed by simply sending a data packet from the client device to the new access point with the implication being that the client device wishes to roam to it. Either implementation is significantly less complex and much faster than roaming under IEEE 802.11r since no authentication process, association process and/or key exchange process is required. As such, in accordance with embodiments of the present invention, the wireless switch architecture in combination with the custom drivers 506, 535 and IBSS mode communication between the client device and access point allows for low latency roaming when a client device roams between access points as there is no need to comply with authentication/association procedures normally associated with BSS mode communications. This low latency roaming technique can provide a number of benefits, such dramatic improvements in voice quality for VOIP sessions.

Improved Roaming Decisions

In conventional IEEE 802.11 networks, the client device is responsible for selecting an access point to roam to, but the IEEE 802.11 standards do not describe how client devices should decide to roam. Access points have a passive role in this selection decision.

Another example of enhanced functionality provided via the custom drivers 506, 535 of client device 560A and infrastructure device 554 relates to improved roaming decisions. In the disclosed embodiments, the custom drivers 506 can work with software at the wireless switch (e.g., custom driver 535 of the infrastructure device 554) to make more informed roaming decisions. In essence, the wireless switch can now take an active role and influence the client device's decision in selecting an access point to roam to. For instance, in one implementation, rather than having the client device 560A just probe access points to find the “best one,” the custom driver 506 of client device 560A can include functionality which allows the client device 560A to actually send data to different access points in order to assess the quality of communications with the access point. In some implementations, the custom driver 506 of client device 560A can include functionality which allows the client device 560A to query the wireless switch 554 about nearby access points to obtain more information to make an informed roaming decision.

Concurrent Operation Using Multiple Access Points

In some situations it would be desirable if a client device could separate its transmission of data traffic (e.g., in 2.4 GHz band of IEEE 802.11b/g) and voice traffic (e.g., in 5 GHz band of IEEE 802.11a since the 5 GHz band is less crowded and has more capacity). With conventional IEEE 802.11 access points this is not possible since NICs are designed to associate with and hence communicate with one access point at a time on a single channel. In conventional IEEE 802.11 compliant networks, a client device typically sends packets to a single access point (i.e., the one it is currently associated with), and an access point can either unicast packets to a single client device or broadcast the same packets to multiple client devices.

Another enhancement enabled by the disclosed embodiments relates to concurrent operation using multiple access points. As mentioned above, in wireless switch architectures, the client device 560A is really associated with the wireless switch, and not a particular access point. In the disclosed embodiments, because the NIC 502 operates in IBSS mode, the NIC 502 can potentially communicate with more than one access point, on more than one channel, since the NIC 502 is not restricted in terms of how it transmits; rather, a NIC 502 operating in IBSS mode is permitted to send packets to any access point, anytime it desires. The custom driver 506 of client device 560A can include functionality which allows the driver 506 to separate packets according to user requests and forward packets accordingly. For example, the custom driver 506 of client device 560A can separate data packets from voice packets, and the NIC 502 can communicate data packets with an IEEE 802.11b/g access point at 2.4 GHz, while simultaneously communicating voice packets with an IEEE 802.11a access point at 5 GHz thereby enabling the NIC 502 to operate concurrently with different access points operating in each band.

Communication with Multiple Access Points

Another example of enhanced functionality provided via the custom driver 506 of client device 560A relates to the capability to send packets (e.g., voice packets) to multiple access points. The client device 560A can send alternate packets to alternate access points or can send multiple copies of the same packet to different access points. Packets sent from access points to client devices can include packets for multiple devices. One device would then send an acknowledgment (ACK) message confirming receipt of a particular packet, and other devices could simply receive the particular packet and “listen” without sending an acknowledgment (ACK) message.

Header Compression and Audio Codec Transcoding

In some communication systems (e.g., a Voice-over-IP or Voice-over-WiFi system), much of the packet is dedicated to information, such as headers, that tends to be repetitive from one packet to the next packet. For example, if a packet is transmitted at a certain rate (e.g., every 40 ms), the packet might have a 100 byte header and 40 bytes of actual voice data. Many of the fields that make up the header information do not change on a packet by packet basis. Thus, much of the packet is “wasted” in communicating the header information since much of the same information is being sent with the header of each packet.

In other types of communication systems, header compression techniques are often applied to reduce the transmission of redundant information by sending the full header once and then sending only the delta information that changes from one packet to the next packet. However, in conventional 802.11 systems, header compression is not possible because the IEEE 802.11 standards prohibit header compression (i.e., IEEE 802.11 standards require that the complete packet is transmitted each time).

By contrast, the disclosed embodiments can enable header compression because communications take place in IBSS mode and therefore do not require strict compliance with the IEEE 802.11 standards. Given the headers associated with VOIP packets are often larger than the data part, this could increase the number of calls supported by a network.

Similarly, another example of enhanced functionality provided via the custom driver 506 of client device 560A relates to enabling audio codec transcoding techniques. Transcoding refers to the direct digital-to-digital conversion from one codec to another, and involves decoding/decompressing the original data to a raw intermediate format (i.e. PCM for audio) in a way that mimics standard playback of the lossy content, and then re-encoding this raw intermediate data into the target format. For example, in some transcoding techniques, a bit stream in one format is decoded using compatible decoder, and then re-encoded using encoder of different standard. In other transcoding techniques, the bit stream format is changed from one standard to another without undergoing complete decoding and encoding process. Many algorithms exist to achieve this.

IBSS Network as an “Out-of-Band” Network

In some scenarios, a client device needs to be configured with certain configuration information in order to properly operate in BSS mode.

Yet another enhancement that is enabled by the custom drivers 506, 535 and IBSS mode communication between the client device 560A and the infrastructure device 554 can be referred to as a “zero configuration” enhancement, where the IBSS network is used as an “out of band” network, for example, to distribute configuration information (e.g., network parameters, security information, etc.) for configuring the client device to the client device 560A from the wireless switch. In one implementation, the custom driver 506 at the client device 560A can include pre-configured software that communicates with the wireless switch using the IBSS mode of operation so that the wireless switch can download configuration information to the client device 560A that the client device 560A needs to operate in standard IEEE 802.11 BSS mode (e.g., ESS-IDs and security information prior to operation of a BSS network).

Infrastructure Assisted Client-Client IBSS Data Transfers

In conventional IEEE 802.11 BSS networks, when a client device would like to send information to another client device, the client device transmits this information to an access point, and the access point re-transmits or relays this information to the other client device. As such, at a minimum, three entities are involved in two separate, redundant over-the-air communications of the same data. Another example of enhanced functionality provided via the custom driver 506 of client device 560A relates to enabling more efficient client-to-client data transfers. Such client-to-client data transfers would be enabled via the infrastructure device 554, but would take place between client devices. The custom driver 506 operating at a client device 560A can include functionality that allows the wireless switch/AP 554 to provide that client device 560A with a list of other neighboring client devices that are currently within proximity of the client device 560A and other information (e.g., security key information for each neighboring client device). The client devices could then use this information to make client-client data transfers as desired. The client device 560A can then communicate data directly to the neighboring client devices directly in IBSS mode without implicating the infrastructure device (i.e., access point and wireless switch) for the data transfer. This would significantly reduce network traffic. This is slightly different than regular IBSS communications between the client devices since it is assisted by the infrastructure devices, and does not require the client devices to set up an IBSS network. In one implementation, the wireless switch can send its client devices scheduling information that specifies timing information for data transfers between particular pairs or sets or groups of client devices.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A system, comprising:
a client device operating in pseudo-Basic Service Set (BSS)/Independent Basic Service Set (IBSS) mode and being configured to wirelessly communicate with the infrastructure device in Independent Basic Service Set (IBSS) mode over a pseudo-BSS/IBSS air interface, wherein the client device comprises:
a client host system, comprising:
one or more upper protocol layer modules;
a client custom driver module that provides one or more pseudo-Basic Service Set (BSS)-like services with respect to packets generated by the upper protocol layer modules to generate one or more pseudo-Basic Service Set (BSS)-like packets; and
a WLAN NIC driver module that is configured to operate in IBSS mode and to receive the one or more pseudo-BSS-like packets from the client custom driver module; and
a first WLAN Network Interface Card (NIC) operating in IBSS mode and being communicatively coupled to the WLAN NIC driver module to receive the one or more pseudo-BSS-like packets from the WLAN NIC driver module, wherein the first WLAN NIC is designed to generate one or more pseudo-BSS/IBSS mode packets based on the one or more pseudo-BSS-like packets, and to transmit the one or more pseudo-BSS/IBSS mode packets; and
an infrastructure device comprising:
a hardware interface designed to operate one or more of pseudo-BSS/IBSS mode, normal BSS mode, and normal IBSS mode, and being configured to receive packets transmitted over air interfaces from one or more client devices including the client device; and
a host system, comprising:
a packet separation driver module that is designed to receive packets from the hardware interface and to separate the packets according to packet type and to send the packets to a correct driver module based on the packet type; and
an infrastructure custom driver module that is configured to receive a pseudo-BSS/IBSS mode packet from the packet separation driver module when the packet separation driver module determines that the packet type is a pseudo-BSS/IBSS mode packet type and to perform one or more BSS-like services with respect to the pseudo-BSS/IBSS mode packet.

2. The system of claim 1, wherein the client custom driver module and the one or more upper protocol layer modules interact with the first WLAN NIC via WLAN NIC driver module.

3. The system of claim 2, wherein the WLAN NIC driver module issues commands to the first WLAN NIC when the client custom driver module invokes a routine in the WLAN NIC driver module.

4. The system of claim 3, wherein the WLAN NIC driver module invokes functionality at the client custom driver module upon receiving an IBSS mode packet from the first WLAN NIC.

5. The system of claim 1, wherein the BSS-like services provided by the client custom driver module provide BSS mode functionality that allows a Basic Service Set (BSS)-like network to be implemented over an IBSS mode air interface.

6. The system of claim 5, wherein the BSS-like services provided to the upper layers comprise IEEE 802.11 standard BSS mode network services and functionality comprising at least one of:
an association service, a disassociation service, a reassociation service, a distribution service, an integration service, an authentication service, a deauthentication service, a confidentiality/privacy service, a data delivery service, a transmit power control service, a dynamic frequency selection service, and a mobility support service.

7. The system of claim 1, wherein the client custom driver module operates transparently with respect to the one or more upper protocol layer modules operating above the client custom driver module.

8. The system of claim 1, wherein the client custom driver module operates transparently with respect to the WLAN NIC driver module operating below the client custom driver module.

9. The system of claim 1, wherein the host system of the infrastructure device further comprises:
a MAC layer packet forwarding module, and
wherein the infrastructure custom driver module provides BSS-like services and enhanced functionality with respect to the pseudo-BSS/IBSS mode packet before passing the pseudo-BSS/IBSS mode packet to the MAC layer packet forwarding module.

10. The system of claim 1, wherein the infrastructure device is capable of concurrently operating in any one of a pseudo-BSS/IBSS mode, a BSS mode, and an Independent Basic Service Set (IBSS) mode.

11. A system according to claim 1, wherein the infrastructure device comprises:
an access point.

12. A system according to claim 11, wherein the infrastructure device further comprises:
a wireless switch coupled to the access point.

13. The system of claim 1, wherein the client custom driver module provides one or more enhanced functions with respect to packets generated by the upper protocol layer modules, wherein the enhanced functions correspond to one or more enhanced functions provided by the second customer driver module of the infrastructure device.

14. The system of claim 13, wherein the one or more enhanced functions are enabled by IBSS mode communications between the client device and the infrastructure device over the pseudo-BSS/IBSS air interface.

15. The system of claim 13, wherein the client custom driver module modifies packets from the upper protocol layer modules according to the one or more enhanced functions provided by the client custom driver module before passing the modified packets to the NIC driver module.

16. The system of claim 15, wherein the enhanced functions provided by client custom driver module do not impact functionality required by the IEEE 802.11 standards.

17. The system of claim 13, wherein the one or more enhanced functions comprise:
enhancements to IEEE 802.11 standard BSS mode network services and functionality and functionality.

18. The system of claim 1, wherein the packet types comprise a normal Basic Service Set (BSS) mode packet type, a normal Independent Basic Service Set (IBSS) mode packet type, and a pseudo-BSS/IBSS mode packet type, and wherein the packet separation driver module is designed to separate the packets according to respective packet types and to send the packets to a correct driver module based on whether the packet type is the normal BSS mode packet type, the normal IBSS mode packet type, or the pseudo-BSS/IBSS mode packet type.

19. The system of claim 1, further comprising:
a second client device being configured to wirelessly communicate with the infrastructure device over a BSS air interface, wherein the second client device comprises:
a second WLAN Network Interface Card (NIC) operating in BSS mode.

20. The system of claim 19, further comprising:
a third client device being configured to wirelessly communicate with the infrastructure device over an Independent Basic Service Set (IBSS) air interface, wherein the third client device comprises:
a third WLAN Network Interface Card (NIC) operating in Independent Basic Service Set (IBSS) mode.
